(19) United States
(12) Patent Application Publication
(10) Pub. No.: US 2005/0227040 A1
(43) Pub. Date: Oct. 13, 2005

(54) Board formed from a wood fiber composite

(76) Inventor: John M. Toupalik, Findlay, OH (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/105,145

(22) Filed: Apr. 13, 2005

Related U.S. Application Data
(60) Provisional application No. 60/561,627, filed on Apr. 13, 2004.

(51) Int. Cl. B32B 21/02; B32B 21/08; B32B 27/42; B32B 3/10

(52) U.S. Cl. 428/131; 264/122; 428/537.1; 428/528; 428/326; 428/174; 428/137

(57) ABSTRACT

The subject invention provides a board (20), which may be formed into a sheet or a structural assembly, such as a pallet. The board (20) includes a core layer (22) including a mixture of wood chips (24) and wood fibers (26) evenly blended throughout the core layer (22). Accordingly, the core layer (22) includes both the wood chips (24) and the wood fibers (26) blended together in an even distribution of each throughout the core layer (22). The board (20) may be formed in a mold (44) to define a three-dimensional shape and include openings (32) therethrough. Additionally, an indentation (34) may be formed in the board (20).

### CROSS REFERENCE TO RELATED APPLICATION

This application claims the benefit of the provisional patent application Ser. No. 60/561,627 filed on Apr. 13, 2004.

### BACKGROUND OF THE INVENTION

1. Field of the Invention

The subject invention relates to a composite board and a method of manufacturing the same.

2. Description of the Prior Art

It is well known to make composite boards from wood chips or wood fibers. Such composite boards are commonly referred to as oriented strand board (OSB), medium density fiberboard (MDF), and high density fiberboard (HDF).

OSB boards are manufactured from a plurality of wood chips of varying size, which are coated with and adhesive. The wood chips are generally placed on a platen and compressed at high heat to form the OSB board. The OSB boards are strong, resistant to warping and suitable for such applications as roof and floor sheathing. However, the OSB boards have a rough outer surface and a plurality of voids between the wood chips, which are exposed on the outer edges of the OSB board.

MDF and HDF boards are manufactured form a plurality of mechanically digested wood fibers, which are mixed with an adhesive. The mixture of the wood fibers and the adhesive is placed in a mold and compressed at high heat to form the MDF and HDF boards. The difference between the MDF board and the HDF board is the relative density to which each is compressed, HDF being compressed to a higher density than MDF. MDF and HDF boards provide a smooth surface and smooth edges that are suitable for finishing, but not nearly as strong as the OSB board.

U.S. Pat No. 3,011,938 to Chapman discloses a method of making a board product. The board product includes a core layer of wood chips mixed with an adhesive. A first outer layer and a second outer layer are disposed on opposing surfaces of the core layer. The first and second outer layers include a mixture of wood fibers and an adhesive. The board of the '938 patent to Chapman is produced by laying a web of the wood fibers and the adhesive on a platen and compressing the web into the first outer layer. The mixture of wood chips and adhesive is then placed on the first layer and compressed to form the core layer. Another web of the wood fibers and the adhesive are placed on the board assembly and compressed to form the second outer layer. The first outer layer, the core layer, and the second outer layer are then compressed at a considerably higher pressure to form the board product. The board product of the '938 patent has the structural integrity of an OSB board with an outer surface of an MDF board. However, the voids between the wood chips in the core layer are still exposed along the edges of the board product.

Accordingly, it would be advantageous to develop a composite board that has the strength of the OSB board with no voids therein and with the exterior characteristics of the MDF and HDF boards.

### SUMMARY OF THE INVENTION AND ADVANTAGES

1The subject invention provides a composite board including a core layer having a mixture of a plurality of wood chips and a plurality of wood fibers blended together in an even distribution of each throughout the core layer wherein the wood chips are evenly distributed throughout the mixture and the wood fibers are also evenly distributed throughout the mixture.

The subject invention also provides a method of manufacturing the composite board. The method includes the steps of forming the mixture in a mold to define the core layer; compressing the core layer to form the board; and blending the mixture of the wood chips and the wood fibers in an even distribution of each prior to forming the core layer. The wood chips and the wood fibers are therefore evenly distributed throughout the core layer.

Accordingly, the subject invention provides a board with virtually no voids therein, thereby providing a sharp edge when cut and an outer surface suitable for finishing. Additionally, the board is dimensionally stable and does not include a predominant grain or knots therein.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the composite board;

FIG. 2 is a cross sectional view of a core layer in a mold before compression;

FIG. 3 is a cross sectional view of the core layer in the mold after compression;

FIG. 4 is a perspective view of a second embodiment of the composite board;

FIG. 5 is a cross sectional view of the core layer and the outer layers of the second embodiment in a mold before compression;

FIG. 6 is a cross sectional view of the core layer and the outer layers of the second embodiment in a mold after compression;

FIG. 7 is a cross sectional view of the core layer and the outer layers of a third embodiment in a mold before compression; and

FIG. 8 is a cross sectional view of the core layer and the outer layers of the third embodiment in a mold after compression.

### DETAILED DESCRIPTION OF THE INVENTION

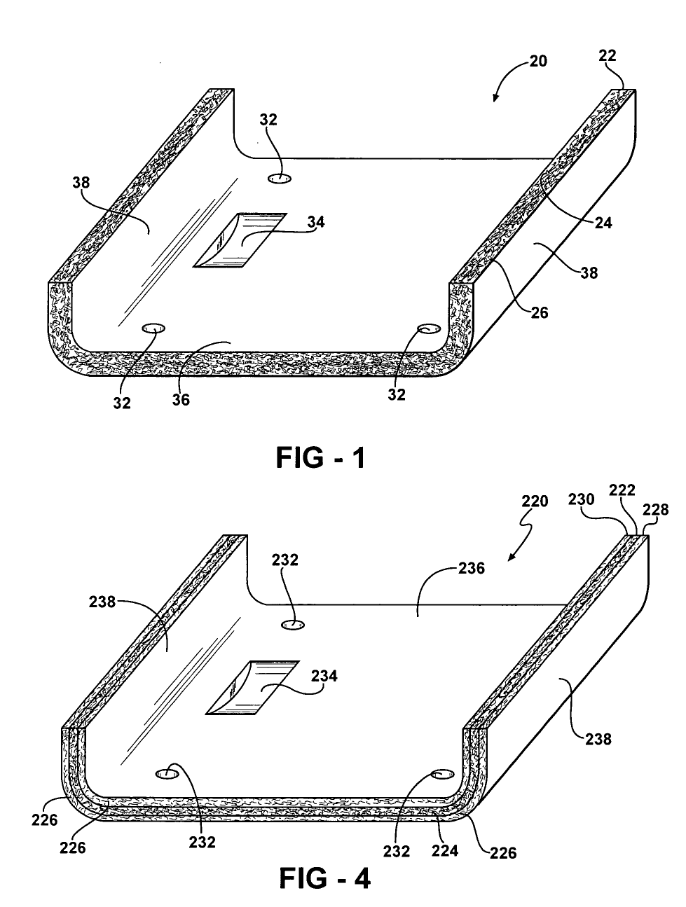

Referring to the Figures, wherein like numerals indicate corresponding parts throughout the several views, a composite board of a first embodiment is shown generally at 20 in FIG. 1.

The board 20 may be formed into a sheet, or into a support assembly. As shown in FIG. 1, the board 20 is preferably formed as a shipping pallet. The shipping pallet is primarily designed as a shipping base for a number of different large bulk items, such as appliances, rolls of metal, and other similar items. The shipping pallet may also be used as a base for a crate or a box to ship bulk items such as bicycles, motorcycles, jet skies, lawn mowers, snow throwers, and the like. Additionally, the board 20 may also be formed into a block and used as a spacer. It should be appreciated that any discussion of the board 20 formed as a shipping pallet or some other object is merely for illustrative purposed and in no way limits the scope of the subject invention.

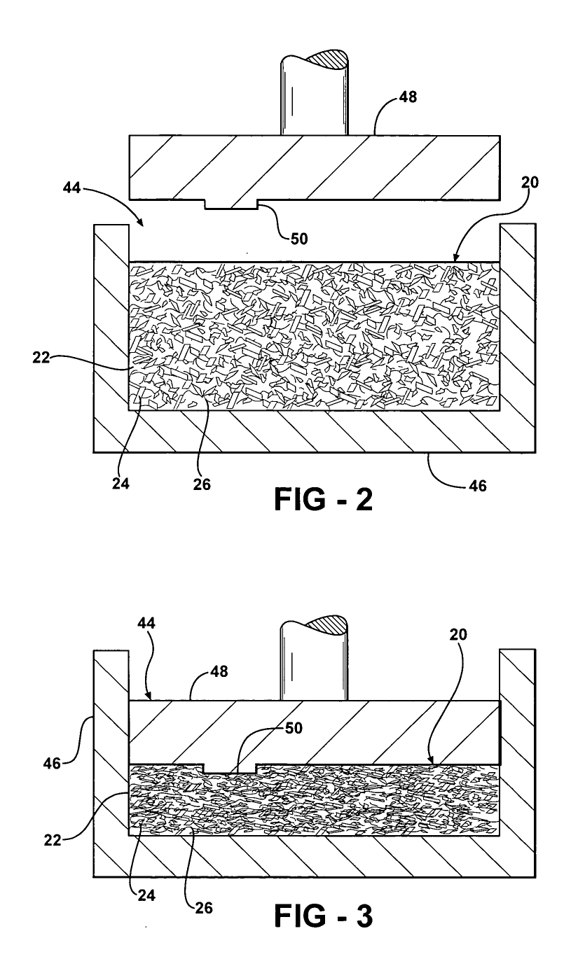

As also shown in FIGS. 2 and 3, the board 20 includes a core layer 22 having a mixture of a plurality of wood chips 24 and a plurality of wood fibers 26 that are blended together in an even distribution of each throughout the core layer 22. Accordingly, the core layer 22 includes both the wood chips 24 and the wood fibers 26, wherein both the wood chips 24 and the wood fibers 26 are blended together and evenly distributed throughout the core layer 22. The board 20 is moisture resistant and preferably not finished, coated, laminated, or overlaid with and additional materials. Additionally, the board 20, once compressed as shown in FIG. 3, is dense, flat, and stiff, includes no knots, and is easily machined.

The wood chips 24 preferably include a length less than three inches (3″) and greater than one quarter of an inch (¼″); a width less than one half of an inch (½″) and greater than one quarter of an inch (¼″); and a thickness less than one quarter of an inch (¼″). The wood fibers 26 are discrete elements of a celluloseic material. The wood chips 24 and the wood fibers 26 can be all from a hardwood, all from a softwood, or a combination of both a hardwood and a softwood.

The mixture preferably includes a ratio of the wood chips 24 to the wood fibers 26, with the wood chips 24 in the range of zero point five percent (0.5%) and ninety five point five percent (95.5%) of the mixture by weight. The mixture of wood chips 24 and wood fibers 26 may also include a plurality of pulped products, up to ten percent (10%) of the mixture by volume.

The mixture includes an adhesive between the range of five percent (5%) and twenty five percent (25%) of the mixture by volume. The adhesive is for bonding the wood chips 24 and the wood fibers 26 together. The adhesive is preferably a urea-formaldehyde resin; however, the adhesive may also be plant based. The plant based adhesive can be a pre-prepared resin or be in a powder form that is activated by heat.

The board 20 preferably includes at least one opening 32 defined by the board 20 and extending therethrough. The opening 32 may extend entirely through the board 20 or only partially through the board. Also, the opening 32 may be stepped or of any other configuration. Additionally, an indentation 34 of any suitable configuration may be formed in the board 20. The opening 32 and the indentation 34 may be formed within a portion of the core layer 22 during the compression of the board. It should be appreciated that the openings 32 and the indentations 34 may have any suitable configuration or be completely omitted without deviating from the overall scope of the subject invention. As noted above, the board 20 can be molded into any suitable shape. As illustrated, the board 20 includes a planar portion 36 and at least one upstanding edge 38 extending from the planar portion 36 at an angle relative thereto. It should be appreciated that the board 20, as illustrated in FIG. 1, is for illustrative purposes only and should not limit the scope of the invention.

A method of manufacturing the first embodiment of the composite board 20 is best shown in FIGS. 2 and 3. Initially, the wood chips 24 are passed through a refiner that breaks the wood chips 24 down to a mechanically digested fiber. The adhesive is added to the fiber and dried to a moisture content between the range of one percent (1%) and eleven percent (11%). Preferably, the moisture content is approximately six percent (6%). It should be appreciated that the adhesive could be added during or after the drying step. The dried wood chips 24, having a moisture content of less than fifteen percent (15%), are mixed with additional adhesive and then added to the fiber/adhesive mixture to form a blended wood fiber 26 composite. The wood chips 24 and the wood fibers 26 are blended together in an even distribution of each throughout the mixture. Additional compounds can also be mixed into the composite at this time. The additional compounds can include, for example, a wax or an anti-fungal agent.

The blended wood chip 24 and wood fiber 26 mixture is then placed within a mold 44. The mold 44 can perform any suitable series of pre-compressing, compressing, and/or heating steps to obtain the desired shape of the board 20. Preferably, the mold 44 has a bottom portion 46 that carries the board 20 between different stations. In a first station (not shown), the mold 44 includes a first top portion (not shown) for pre-compressing the mixture into the core layer 22. As an example, the mixture could be pre-compressed from a thickness of approximately nine inches down to approximately there inches (3″). The bottom portion 46 then carries the core layer to a second station, which is shown in FIGS. 2 and 3. The mold 44 at the second station includes a second top portion 48 for completely compressing the core layer 22 into the board 20. Typically, heat is also applied at the second station during the compressing process. The core layer 22, for example, is now pressed from the approximately three inches (3″) down to the final desired thickness of three quarters of an inch (¾″) to one half of an inch (½″). It should be appreciated that any number of pre-compressing steps may be performed as desired.

The openings 32 and the indentations 34 of the board 20 are preferably formed during the compression of the board 20. The mold 44 preferably includes at least one protrusion 50, which extends from the mold 44 and is pressed into the board 20 during compression thereof to form the openings 32 or the indentations 34. It should be appreciated that the protrusions 50 may be of any suitable shape and size to define the shape and size of the openings 32 and the indentations 34. The protrusions 50 may be included in either the bottom portion 46 or the top portion 48 of the mold 44 to form the openings 32 or the indentations 34 in either of the opposing surfaces of the board 20.

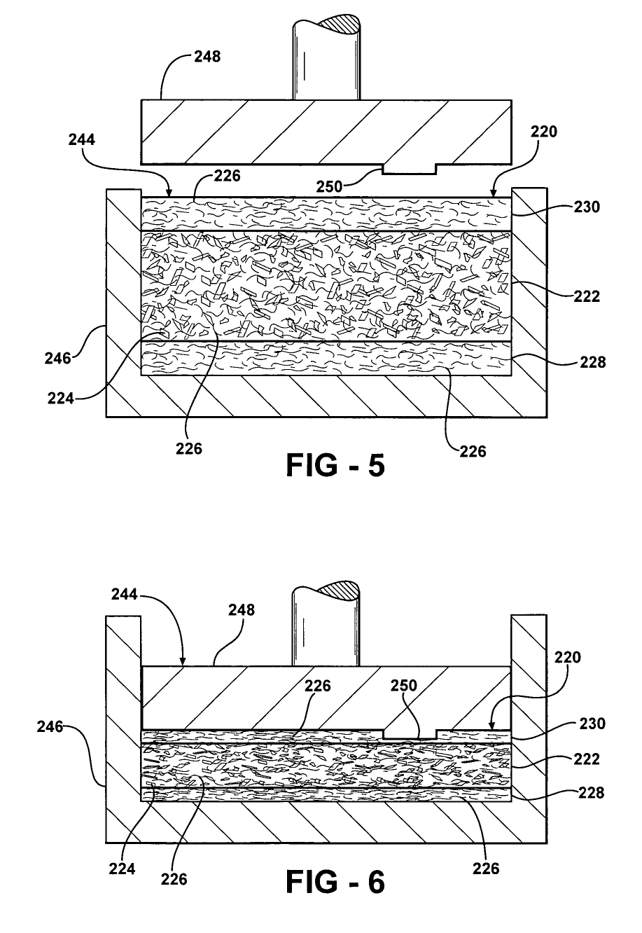

A second embodiment of the board 220, wherein like numerals increased by 200 indicate like or corresponding parts, is shown in FIGS. 4-6. As depicted in FIG. 4, and referring to FIGS. 5 and 6, the board 220 includes a first outer layer 228 and a second outer layer 230 disposed on opposing surfaces of the core layer 222. It should be appreciated that the board 220 may only include the first outer layer 228, and not the second outer layer 230. The first outer layer 228 and the second outer layer 230 are formed from a plurality of medium density wood fibers 226 and an adhesive. The medium density wood fibers 226 are used to manufacture medium density fiberboard (MDF). The medium density wood fibers 226 can be all from a softwood, all from a hardwood, or a combination of both a softwood and a hardwood. Recycled papers may be mixed with the medium density wood fibers 226 and be in the range of one thousandth of a percent (0.001%) to ninety nine (99%) of the wood fiber mixture.

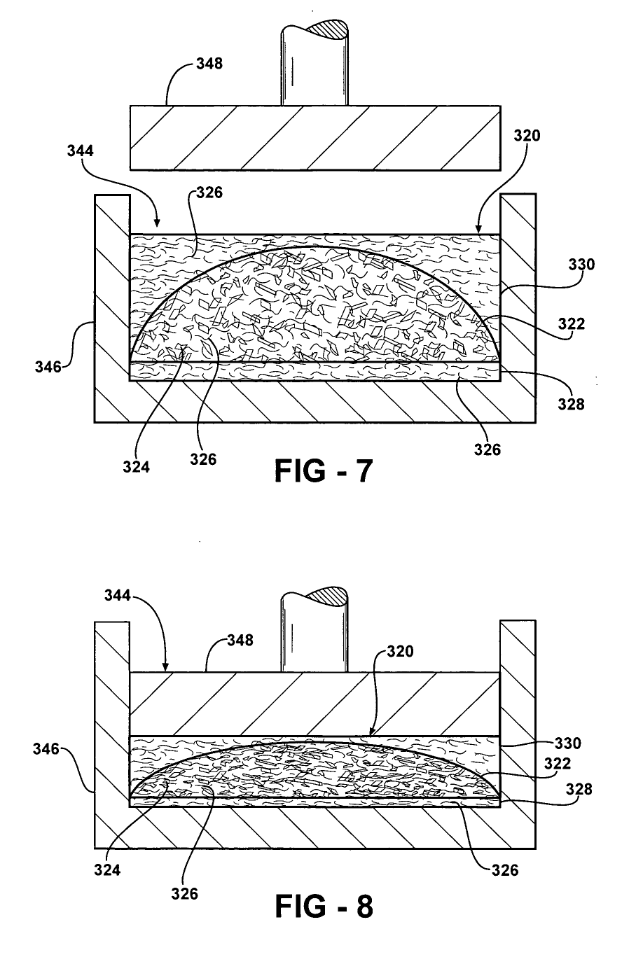

A third embodiment of the board 320, wherein like numerals increased by 300 indicate like or corresponding parts, is shown in FIGS. 7 and 8. Referring to FIGS. 7 and 8, the core layer 322 includes a non-uniform cross section. The non-uniform cross section of the core layer 322 preferably includes a dome shaped cross section 340. The first outer layer 328 includes a non-uniform cross section having a bowl shape 342 complimentary to the dome shape of the core layer 322. The second outer layer 330 of the board 320 is illustrated as having a uniform cross section. It should be appreciated, however, that the second outer layer 330 may have a non-uniform cross section as well; and the core layer 322 and the first outer layer 328 may include any suitable complimentary cross section desired for the board 320.

The second embodiment of the board 220 is manufactured in a similar manner as the first embodiment of the board 20. The method of manufacturing the second embodiment of the board 220 includes placing a mat of the wood fibers 226 mixed with the adhesive in the mold 244 and pre-compressing the mat into the first outer layer 228; placing the mixture of the wood chips 224, the wood fibers 226, and the adhesive on the first outer layer 228 and pre-compressing the mixture into the core layer 222; and placing a second mat of the wood fibers 226 mixed with the adhesive on the core layer 222 and pre-compressing the second mat into the second outer layer 230. The first outer layer 228, the core layer 222, and the second outer layer 230 are then compressed at a higher pressure to form the composite board 220. The mixture of the wood chips 224 and the wood fibers 226 used for the core layer 222 of the second embodiment of the board 220 is manufactured in the same manner as the mixture used for the core layer 22 of the first embodiment of the board 20. Additionally, the openings 232 and the indentations 234 of the second embodiment of the board 220 are formed in the same manner as the first embodiment of the board 20. It should be appreciated that the openings 232 of the second embodiment of the board 220 will extend through the first outer layer 228, the core layer 222, and the second outer layer 230; and the indentations 234 of the second embodiment of the board 220 will be formed in either the first or second outer layers 228, 230 of the board 220. The third embodiment of the board 320 is also manufactured in a similar manner as the first and second embodiments of the board 220 as described above.

The foregoing invention has been described in accordance with the relevant legal standards; thus, the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A composite board (20) comprising:
a core layer (22) including a mixture of a plurality of wood chips (24) and a plurality of wood fibers (26) blended together in an even distribution of each throughout said core layer (22) wherein said wood chips (24) are evenly distributed throughout said mixture and wherein said wood fibers (26) are evenly distributed throughout said mixture.

2. A board (20) as set forth in claim 1 wherein said wood chips (24) include a length less than three inches (3″) and greater than one quarter of an inch (¼″), a width less than one half of an inch (½″) and greater than one quarter of an inch (¼″), and a thickness less than one quarter of an inch (¼″).

3. A board (20) as set forth in claim 1 wherein said mixture includes an adhesive between the range of five percent (5%) and twenty five percent (25%) of said mixture by volume for bonding said wood chips (24) and said wood fibers (26) together.

4. A board (20) as set forth in claim 3 wherein said adhesive is a urea-formaldehyde resin.

5. A board (20) as set forth in claim 3 wherein said adhesive is a plant based.

6. A board (20) as set forth in claim 1 wherein said board (20) includes a first outer layer (28) and a second outer layer (30) disposed on opposing surfaces of said core layer (22).

7. A board (20) as set forth in claim 6 wherein said first outer layer (28) and said second outer layer (30) include a plurality of medium density wood fibers (MDF) (26).

8. A board (20) as set forth in claim 7 wherein said MDF includes a plurality of pulped products up to ten percent (10%) of said mixture by volume.

9. A board (20) as set forth in claim 6 wherein said core layer (22) includes a non-uniform cross section.

10. A board (20) as set forth in claim 9 wherein said non-uniform cross section of said core layer (22) includes a domed shape.

11. A board (20) as set forth in claim 10 wherein said first outer layer (28) includes a non-uniform cross section having a bowl shape (42) complimentary to said dome shape of said core layer (22).

12. A board (20) as set forth in claim 1 wherein said board (20) defines an opening (32) therethrough.

13. A board (20) as set forth in claim 12 including a planar portion (36) and at least one upstanding edge (38) extending from said planar portion (36) at an angle relative thereto.

14. A board (20) as set forth in claim 13 wherein said board (20) defines an indentation (34) therein.

15. A method of manufacturing a composite board (20) including a core layer (22) having a mixture of wood chips (24) and wood fibers (26) comprising the steps of:
forming the mixture in a mold (44) to define the core layer (22),
compressing the core layer (22) to form the board (20), and
blending the mixture of the wood chips (24) and the wood fibers (26) in an even distribution of each prior to forming the core layer (22) wherein the wood chips (24) are evenly distributed throughout the mixture and wherein the wood fibers (26) are evenly distributed throughout the mixture.

16. A method as set forth in claim 16 wherein said step of blending the mixture is further defined as blending the wood chips (24) and the wood fibers (26) and an adhesive to form the mixture.

17. A method as set forth in claim 16 wherein said step of blending is further defined as blending the wood fibers (26) and the adhesive together before blending the wood chips (24) into the mixture.

18. A method as set forth in claim 17 including heating the core layer (22) during compression thereof.
